(19) United States
(12) Patent Application Publication
(10) Pub. No.: US 2008/0279569 A1
(43) Pub. Date: Nov. 13, 2008

(54) Method of adjusting print magnification in digital duplex printing

(75) Inventor: Ellery Wong, Rochester, NY (US)

Correspondence Address: FAY SHARPE / XEROX - ROCHESTER, 1100 SUPERIOR AVE., SUITE 700, CLEVELAND, OH, 44114, US

(73) Assignee: XEROX CORPORATION

(21) Appl. No.: 11/800,748

(22) Filed: May 7, 2007

(51) Int. Cl. G03G 15/00

(52) U.S. Cl. 399/15; 399/81

(57) ABSTRACT

A method of adjusting print magnification in digital duplex printing in which the difference in print magnification from front to back side is measured on a text sheet and the percentage difference calculated. Provision is made for user inputs for adjusting the digital image print magnification laterally and longitudinally whereupon changes are evaluated in another text printing.

### BACKGROUND

The present disclosure relates to printing of digital images and particularly printing by an electrostatic or xerographic process in which an image is generated on a photoreceptor and transferred to a print media sheet and heat fixed thereon. More particularly, the disclosure relates to duplex printing of digital images by the electrostatic processor printing on both sides of the print media sheet.

With the advent of electrostatic photocopiers capable of relatively high production rates, these machines have found particular suitability to printing of documents requiring duplex printing where the individual sheets or pages are subsequently bound into books or pamphlets and the like. However, in duplex printing of sheets or pages intended for binding, in order to provide a quality print job which is competitive in the market place, it is necessary that the print on both sides of the pages be registered or positioned on the page such that there is no noticeable variation to the reader of the print on the page from the first to the second side. It has been found that variations of 2 mm or less in the image registration from Side 1 to Side 2 of a sheet or page are quite noticeable to the eye of the reader and give the impression of a poor quality print job. Accordingly, it has been found necessary to maintain very tight control of the image magnification or registration in duplex printing from Side 1 to Side 2, or front to back, of the printed media sheet.

Maintaining the aforesaid tight control of print magnification from Side 1 to Side 2 in a duplex printing job on an electrostatic photocopier has proven to be difficult and costly in such machines set up for high speed duplex printing. This has been found to be the case irrespective of whether the digital image is transferred directly to the electrostatic printing machine such as from a computer or is generated from a printed sheet inputted for copying and reproduction. The complexity of the processes within the electrostatic print engine including the transport of the paper through the sheet path and heat fusing in the print engine has introduced error in the print magnification and registration from Side 1 to Side 2 on a printed sheet.

Accordingly, it has been desired to provide a way or means of enabling the user to control the quality of the duplex printing with respect to the image magnification and registration on the printed sheet; and, particularly it has been desired to provide the user with a way or means of correcting errors in the print magnification by varying the printing process.

### BRIEF DESCRIPTION

The present disclosure describes a method of enabling the user to adjust the printing process in an electrostatic printer to correct errors of print magnification and registration in duplex printing for maintaining the quality of the print job and particularly for controlling print magnification such that the reader of the printed document will not notice variation in the magnification or registration of the images printed on Side 1 and Side 2 of the printed sheet or page.

The presently described and illustrated method provides a user input panel or interface on an electrostatic reproducing machine upon which the user may enter commands for incrementally changing the longitudinal and lateral magnification of the digital image prior to printing. The user is enabled to determine the desired amount of correction for the print magnification by running a test print and measuring the variation of the print magnification and registration from Side 1 to Side 2, or front to back, of a printed sheet. The percentage change from front to back is then computed; and, the user can input a desired number of predetermined incrementally small changes in the percentage of magnification and view the results on another test print. Once the test prints confirm that the correct preprint magnification corrections have been made to the digital image, the print job may be run in its entirety.

In one embodiment of the method described in the present disclosure, the user inputs the desired corrections for print magnification by analog controls such as, for example, rotating control knobs to a position indicated for the desired amount of correction. In another embodiment of the method described and disclosed herein, the user input panel provides touch screen digital entry of desired amounts of print magnification correction. The method of the present disclosure is described in an exemplary embodiment wherein the user desired corrections are inputted to the digital front end (DFE) or controller for changing the operation of a raster image processor (RIP) prior to printing on the respective Side 1 and Side 2 of the sheet.

### BRIEF DESCRIPTION OF THE DRAWINGS

FIG. 1 a side view of a typical photocopying machine showing the location of the user input panel with the housing broken away to show the paper path through the print engine;

FIG. 2a is a section view taken along section indicating lines 2-2 of FIG. 1 and shows the digital version of the user input panel;

FIG. 2b is a view similar to FIG. 2a of an analog version of the user input panel;

FIG. 3 is a block flow diagram of the method of the present disclosure; and,

FIG. 4 is a block flow diagram of an exemplary embodiment of the method of FIG. 3.

### DETAILED DESCRIPTION

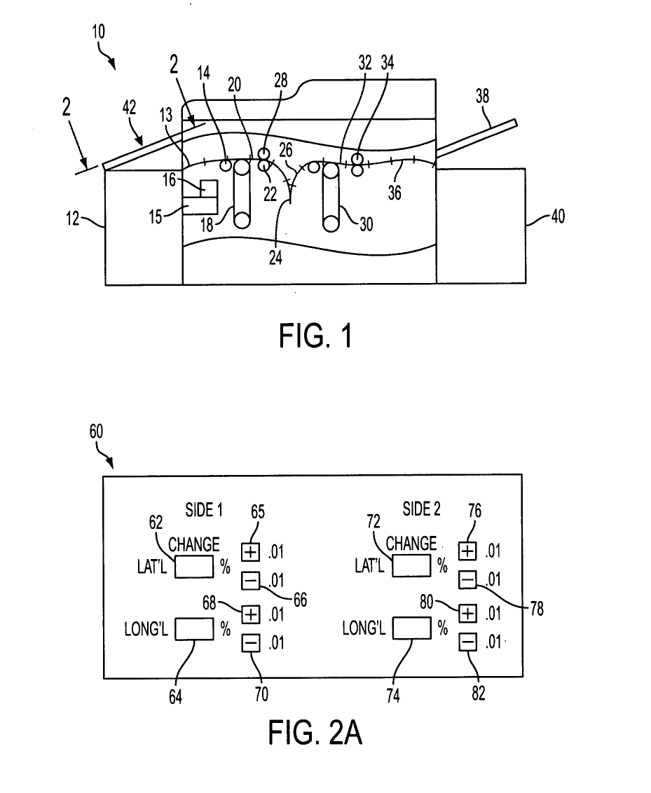

Referring to FIG. 1, a xerographic photocopying/printing machine is indicated generally at 10 and includes a sheet feeder 12 for providing automatic feed of print media sheets along a path 13 to a raster optical scanner (RAS) 14 which receives the image from a raster image processor (RIP) 16 and generates the image on a first photoreceptor 18. The image is then transferred from the photoreceptor 18 onto the print media sheet and fed through a path 20 to a fuser 22 for securing the image on the sheet. The sheet then is fed to an inverter 24 which supplies the sheet along path 26 to a second raster optical scanner receiving an image from the raster image processor 16. The scanner 28 generates an image on the second photoreceptor 30 which transfers the image to Side 2 of the sheet which is fed along path 32 to a fuser 34 for securing the image on Side 2 of the sheet. Alternatively, the sheet may be fed from the inverter back to the first photoreceptor for printing on the second side thereby using only one photoreceptor where it is desired to provide a less costly machine and where the resultant decreased productivity is acceptable. The duplex printed sheet is then fed along a path 36 to a receptacle or tray 38 or alternatively to an automatic stacker 40.

The machine 10 includes a user input panel or console indicated generally at 42 which has provision thereon for manually inputting, to the digital controller or DFE 15 for the machine, desired corrections to the print magnification which controls the raster image processor 16.

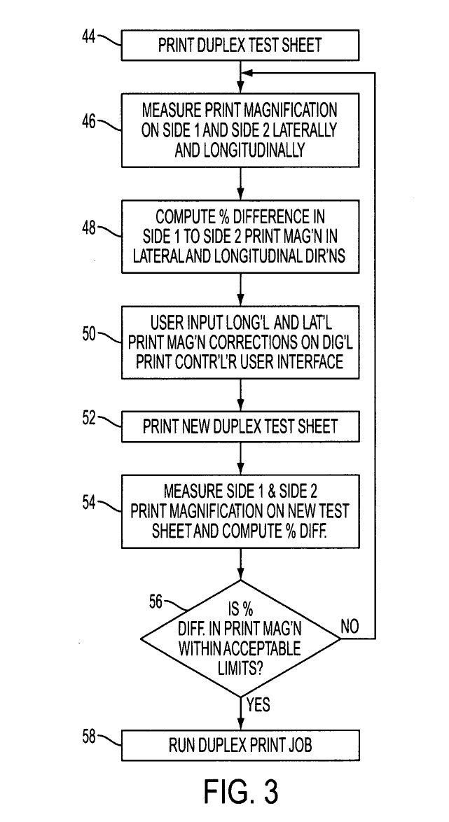

Referring to FIG. 3, the method is described with reference to a block flow diagram wherein an initial duplex test sheet is printed at step 44; and, the user measures the print magnification on Side 1 and Side 2 of the printed sheet at step 46. The user then computes the percentage difference between Side 1 and Side 2 print magnification in both the lateral and longitudinal directions at step 48; and, proceeding to step 50, the user inputs the longitudinal and lateral print magnification corrections from the digital print controller user interface (Reference Numeral 42 in FIG. 1) as will hereinafter be described in greater detail.

At step 52, a new duplex printed test sheet is made and at step 54 the print magnification on Side 1 and Side 2 is measured and the percentage difference in magnification computed by the user. At step 56, a determination is made by the user as to whether the print magnification Side 1 to Side 2 is within acceptable limits; and, if the determination is affirmative the print job is run at step 58.

However, if the determination at step 56 is negative, then it is necessary to return to step 46 and measure the Side 1 and Side 2 magnification and input a new set of corrections to the user interface 42.

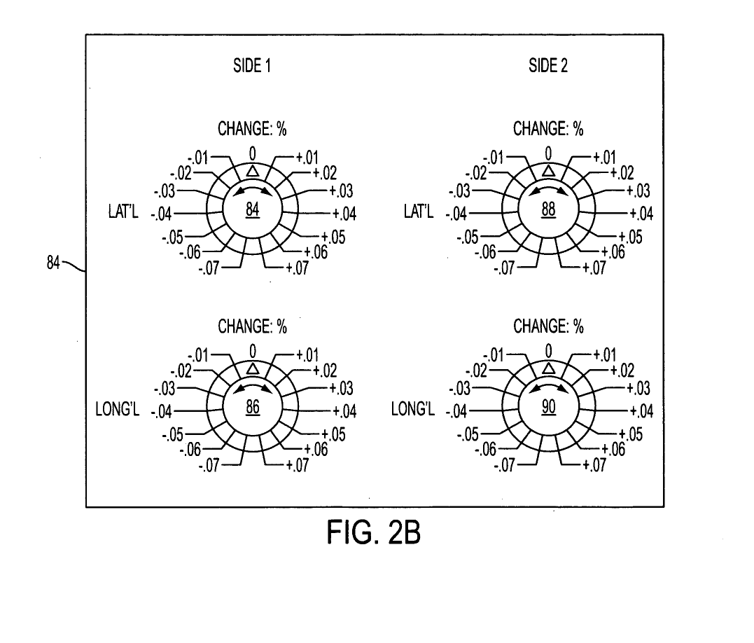

Referring to FIG. 2a, an exemplary embodiment of a digital version of the user interface 42 is indicated at 60 and has a window or indicator 62 for displaying the selected change in the lateral print magnification; and, similarly, panel 60 has a digital indicator or window 64 for indicating the selected change in the longitudinal print magnification. The windows 62, 64 are aligned under the designation for Side 1. Adjacent the window 62 are user tactile input devices such as, for example, pushbuttons or relatively small touch sensitive pads of the type well know in the art, with one input device 66 for incrementally increasing the percentage change of the lateral magnification by 0.01 percent and a second input device 66 for decrementing the lateral magnification by 0.01 percent. Similarly, tactile input devices 68, 70 are provided adjacent window 64 for incrementing and decrementing the longitudinal magnification by 0.01 percent.

User input panel or console 60 also includes separate indicator windows for indicating the selected percentage change of the lateral and longitudinal print magnification for Side 2 of the printed sheet; and, these are denoted respectively by reference numerals 72, 74 in FIG. 2a. The panel 60 also includes tactile input devices 76, 78 disposed adjacent window 72 for respectively inputting incremental and/or decremental changes of 0.01 percent to the lateral print magnification for Side 2. Adjacent window 74 is a pair of tactile input devices 80, 82 operative for the user inputting respectively an increment and a decrement of 0.01 percent change in the longitudinal magnification of Side 2.

Referring to FIG. 2b, another exemplary version of the user interface 42 is indicated at 84 and has a rotatable knob 86 disposed thereon with juxtaposed indicia for selecting a desired lateral percentage change in lateral print magnification. The knob 84 is user rotatable in the clockwise direction for incrementing the percentage change in 0.01 percent increments; and, the knob 86 is rotatable in a counterclockwise direction for decrementing the percentage change in lateral print magnification by 0.01 for each position indicated.

Console 84 has a second knob 86 disposed below knob 84 for user rotation to provide incremental and decremental changes in the percent of longitudinal print magnification by amounts of 0.01 percent for each position of the knob rotation. The clockwise rotation of the knob 86 provides increments of 0.01 percentage change and counterclockwise rotation of the knob 86 providing decremental changes of 0.01 percent of longitudinal print magnification.

Adjacent the right hand side of the console 84 in laterally spaced arrangement is disposed a pair of knobs denoted 88, 90 arranged one under the other for user inputting corrections for print magnification in the printing of Side 2 of the duplex printed sheet. The upper knob 88 is rotatable clockwise for incrementing the lateral print magnification of Side 2 by 0.01 percent for each indicated position of the knob; and, knob 88 is rotatable counterclockwise for decrementing the lateral print magnification by 0.01 percent by each of the rotary positions indicated.

The lower knob 90 is similarly rotatable clockwise for incrementing by 0.01 percent, for each rotary position indicated, the longitudinal print magnification of side 2 of the duplex printed sheet. Counter clockwise rotation of knob 90 provides decrementing of 0.01 percent of longitudinal print magnification for Side 2 of the duplex printed sheet.

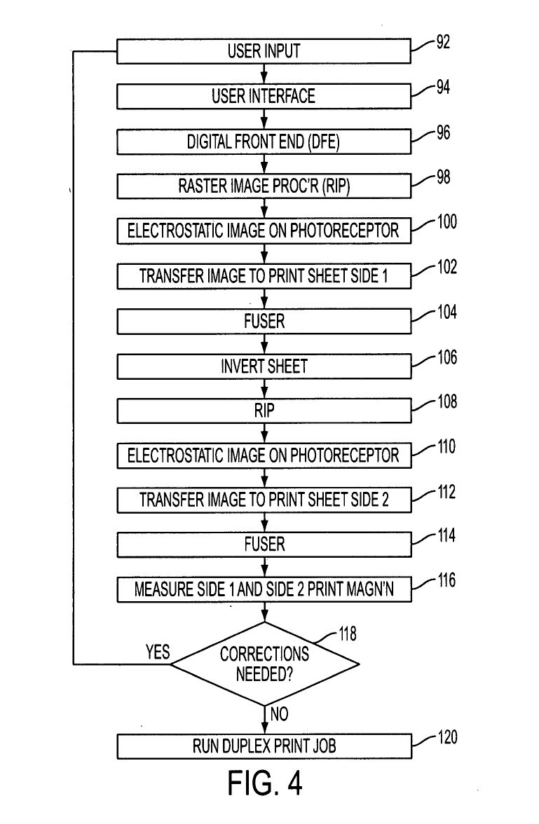

Referring to FIG. 4, an exemplary version of the method of the present disclosure is indicated in block flow diagram where at step 92 the user inputs desired changes to the user interface at step 94 to the system controller or digital front end at step 96 which provides the appropriate signal to the raster image processor (RIP) at step 98. The RIP 98 generates an electrostatic image on the photoreceptor at step 100; and, the print engine 10 is operative to transfer the image created in step 100 to Side 1 of the print sheet at step 102. The sheet is then fed to the fuser at step 104 the image secured and the sheet moved along the path to the inverter at step 106 which inverts the sheet and feeds it, trailing edge first, along a path to a second RIP at step 108, which generates an image in the second photoreceptor on the Side 2 of the sheet at step 110. The image generated at step 110 is then transferred to Side 2 of the print sheet at step 112 and fed along a path to the fuser at step 114 where the image is secured on Side 2 of the print sheet. The user then measures the Side 1 and Side 2 print magnification at step 116; and, at step 118 the user makes the determination whether the print magnification measured in step 116 is within the desired limits or whether correction is needed. If the determination in step 118 is affirmative, the user then again returns to step 92 and inputs additional corrections. However, if the determination at step 118 is negative, duplex print job is then completed at step 120.

The present invention thus provides a method of duplex printing in an electrostatic or xerographic printer with a user interface which permits entering corrections to the print magnification both laterally and longitudinally for Side 1 and Side 2 of the printed sheet based upon the user's measurements from a test print of the print magnification produced by the existing settings of the machine.

It will be appreciated that various of the above-disclosed and other features and functions, or alternatives thereof, may be desirably combined into many other different systems or applications. Also that various presently unforeseen or unanticipated alternatives, modifications, variations or improvements therein may be subsequently made by those skilled in the art which are also intended to be encompassed by the following claims.

1. A method of adjusting print magnification in digital duplex: printing comprising:
(a) printing a duplex print sheet;
(b) measuring the difference in print magnification from Side 1 to Side 2 of the printed sheet and calculating the percentage difference;
(c) providing for user inputs and adjusting the digital image print magnification of Side 2 and compensating for the difference; and,
(d) printing another duplex test print sheet and determining whether further adjusting is required.

2. The method defined in claim 1, wherein the step of providing for user inputs includes providing for one of moving an analog control member and entering digital inputs.

3. The method defined in claim 1, wherein the step of providing for user inputs includes displaying on a screen and the step of providing for user inputs includes providing for tactile inputs.

4. The method defined in claim 1 wherein the step of measuring includes measuring differences in lateral and longitudinal directions; and, the step of calculating the difference includes calculating the percentage difference in the lateral and longitudinal directions of the printed sheet.

5. The method defined in claim 4, wherein the step of adjusting includes adjusting for print magnification in the lateral and longitudinal directions of the printed sheet.

6. The method defined in claim 1, wherein the step of adjusting includes adjusting the digital front end (DFE).

7. The method defined in claim 1, wherein the step of adjusting includes adjusting the scan rate of a raster image processor (RIP).
